(19) United States
(12) Patent Application Publication
(10) Pub. No.: US 2012/0267257 A1
(43) Pub. Date: Oct. 25, 2012

(54) METHOD FOR WATER SANITISATION

(76) Inventors: Ross Leslie Palmer, Mt Gravatt (AU); Stuart Bruce Anderson, Mt Gravatt East (AU)

(21) Appl. No.: 13/512,591

(22) PCT Filed: Nov. 30, 2010
(86) PCT No.: PCT/AU10/01612

§ 371 Date: Jul. 10, 2012

(30) Foreign Application Priority Data
Nov. 30, 2009 (AU) 2009905849

(51) Int. Cl. C02F 1/467; C01F 5/30; A01P 1/00; A01N 59/08

(52) U.S. Cl. 205/751; 423/497; 205/742

(57) ABSTRACT

The present invention provides a method for sanitising water in a swimming pool or the like, which method uses sources of ionic chlorine at significantly lower levels than conventional systems. The method comprises the steps of (i) forming, in the swimming pool water, an electrolyte solution containing from 500 ppm to 9000 ppm of a soluble magnesium halide salt, (ii) treating the electrolyte solution in an electrolytic halogenation cell to form an aqueous solution of hypohalous acid, and (iii) returning the water so treated back to the swimming pool. A mixture of magnesium, potassium and sodium chloride salts with small quantities of a soluble alkaline earth metal bromide, zinc halide, ascorbate, and/or zinc ascorbate may be particularly effective in the sanitisation process.

### FIELD OF THE INVENTION

This invention relates to an improved method of sanitisation of a body of water. The invention is concerned with electrolytic halogenation of water in swimming pools, spas and the like to reduce or minimize the effects of water borne micro-organisms such as bacteria, viruses, algae, parasites and the like. The invention is particularly concerned with a method of water sanitisation that uses sources of ionic chlorine at significantly lower levels than conventional systems.

### BACKGROUND OF THE INVENTION

Progressive climate change is believed to be contributing to reduced rainfall and drought conditions in many regions around the world. Diminishing supplies of water in storage reservoirs and lowering of groundwater tables have lead to the imposition by local government authorities of water restrictions of varying severity upon domestic, commercial and agricultural water users.

While owners of swimming pools can contribute somewhat to water conservation by the use of swimming pool covers or the like to reduce evaporative losses, one major water consuming feature of a swimming pool is the requirement to backwash the pool filtration system to clear the filter of contaminants removed from the pool water or to lower the water level after a rainstorm.

In a typical domestic or commercial swimming pool installation having a volumetric capacity of from 20,000 litres to 1,500,000 litres, a backwash and rinse cycle for a sand filter will consume between 100 litres to 60,000 litres each week depending upon the amount of contamination extracted from the pool water by the filter. During the backwash and rinse cycles, water is drawn from the pool via the filter pump and thence through the filter medium to a storm water drain as required by local government authorities. Similarly, when excess water due to rainfall accumulates in the swimming pool, the level is adjusted by pumping many thousands of litres of excess water to the storm water drain or sewer line.

There are potential disadvantages arising from the currently permitted methods of disposal of waste swimming pool water, either into a storm water drain or to a sewer line.

In a pool which is chlorinated by the addition of sodium or calcium hypochlorite, there are high levels of dissolved salts in the form of sodium or calcium anions whereas in a conventional salt chlorinated pool there are high levels of sodium chloride, typically in a recommended concentration of about 6000 ppm. Apart from very high salt concentrations, waste swimming pool water can also contain chloramine or trihalomethane (THM) compounds arising from the reaction of free chlorine cations with bodily fluids, skin, and other contaminants in the swimming pool water as well as cyanuric acid chlorine stabilizers and live and dead micro organisms such as bacteria, viruses, algae and parasites. The levels of these contaminants are higher is non-residential pools with a large number of bathers which increases the levels of chlorine required to keep these pools sanitised resulting in superchlorinated swimming pools.

As storm water is usually directed from urban areas into pristine waterways such as rivers or the sea, the introduction of swimming pool waste can lead to pollution and environmental damage to native flora and fauna in the waterway adjacent the disposal site. In particular, the introduction of foreign organisms runs a serious risk of introducing pathogenic contamination in marine and human food chains.

Although there is a lower risk of contamination of the environment from swimming pool waste water being directed into a sewer line, high salt content and high chlorine content can interfere with sewage treatment, processes to reduce the efficiency thereof.

Generally speaking, for swimming pools employing an electrolytic chlorine generator, water in the pool is required to contain between 2500 and 6000 ppm of sodium chloride (NaCl) for effective operation of the electrolytic chlorinator. Such a high salt content in the backwash and rinse water renders it unsuitable for collection and use for garden irrigation as in other grey water conservation systems due to the sodicity and gradual accumulation of sodium chloride in the soil leading to degenerative salination of the soil. Ultimately this could give rise to a situation where authorities deem the pool owner's property as a contaminated site requiring expensive rehabilitation.

The present applicant is the Applicant for International Application No WO2008/000029, herein incorporated in its entirety. The invention defined in WO2008/000029, which relates to a system that employs alternative sources of chlorine, was developed to overcome problems associated with conventional sodium chloride sources. However, while lower chloride levels and replacement of at least a portion of the NaCl with alternative sources such as MgCl₂ and KCl has reduced some of the problems associated with heavily chlorinated pools, there are still many environmental and economic problems associated with these systems. For example, unacceptably high levels of chloramines and trihalomethanes, which are the precursors of vital health concerns such as asthma, cancer, and reproductive defects, are still present in most swimming pools.

Furthermore, the fact that many swimming pools contain high levels of phosphates, which act as a primary source of nutrition for algae, has increased the levels of sanitisers required to maintain satisfactory control of algae.

As used herein, the expression “swimming pool” is also intended to embrace the analogous use of spa baths, hot tubs and the like which are operated in a substantially identical manner to swimming pools. Similarly, the expression “backwash” is intended to include all water flows from a swimming pool filter to a storm water drain including backwash, rinse and bypass flows.

### SUMMARY OF THE INVENTION

Accordingly, it is an aim of the present invention to provide a method of water sanitisation that will mitigate one or more of the problems of prior art swimming pools, spas and the like and otherwise to give consumers a convenient choice.

The invention is more particularly concerned with improvements to our prior publication (WO2008/000029), which relates to a method of treatment of a body of water wherein the preferred range of operation for an electrolyte solution was from 1500 ppm to 9000 ppm of a soluble magnesium halide salt.

The present inventors have unexpectedly discovered that the present invention may operate as low as 500 ppm of a soluble magnesium halide salt. The advantages of the lower concentration include lower use of chemicals with associated cost savings. Other advantages include a reduction in chloramines (e.g dichloramines and trichloramines) and trihalomethanes, which are generally characterised as ‘disinfection by-products’ (DBPs) because they emerge as secondary pollutants out of the reaction between chlorine disinfectants and organic pollutants in water.

In one aspect, the invention therefore provides a method for water sanitisation, said method including the steps of forming, in a body of water, an electrolyte solution containing from 500 ppm to 9000 ppm of a soluble magnesium halide salt; treating said electrolyte solution in an electrolytic halogenation cell to form an aqueous solution of hypohalous acid; and returning said treated electrolyte solution to said body of water.

Preferably, said electrolyte solution contains from 700 ppm to 3000 ppm of a soluble magnesium halide salt. More preferably, said electrolyte solution contains from 700 ppm to 1500 ppm of a soluble magnesium halide salt.

Suitably, said electrolyte solution contains from 250 ppm to 4000 ppm of a soluble sodium halide salt. Preferably, said electrolyte solution contains from 375 ppm to 2000 ppm of a soluble sodium halide salt.

Suitably, said electrolyte solution contains from 0 to 4000 ppm of a soluble potassium halide salt. Preferably, said electrolyte solution contains from 0 to 3000 ppm of a soluble potassium salt. More preferably, said electrolyte solution contains from 0 to 2500 ppm of a soluble potassium salt.

If required, the electrolyte solution may contain from 0 ppm to 300 ppm of a soluble alkali metal halide salt selected from LiBr, NaBr, CaBr₂, MgBr₂ or mixtures thereof.

If required, the electrolyte solution may contain from 0 to 1000 ppm of a soluble zinc halide salt.

If required, the electrolyte solution may contain from 0 to 1000 ppm of ascorbic acid.

If required, the electrolyte solution may contain from 0 to 1000 ppm of zinc ascorbate.

Preferably, the magnesium halide, potassium halide and sodium halide salts are chloride salts.

Suitably, said electrolyte solution contains from 1000 ppm to 5000 ppm of soluble metal halide salts. Preferably, said electrolyte solution contains from 1500 ppm to 4000 ppm of soluble metal halide salts. More preferably, said electrolyte solution contains from 2000 ppm to 3000 ppm of soluble metal halide salts.

Suitably, said electrolyte solution is filtered through a filter medium before return to said body of water. Preferably, said filter medium comprises a particulate amorphous siliceous composition. Desirably, said filter medium comprises crushed or milled glass particles.

Preferably, said electrolyte solution is directed to said electrolytic halogenation cell via a settling tank to assist in separation of particulate contaminants. Typically, although not exclusively, said settling tank is a crushed or milled glass filtration tank.

Alternatively, said electrolyte solution is directed, during backwash, rinse or bypass cycle to a collection tank.

According to another aspect of the invention, there is provided an electrolyte salt composition for use with the aforementioned method, said electrolyte salt composition comprising:

| | |
|---|---|
| MgCl₂ | 100-20 wt % |
| KCl | 0-70 wt % |
| NaCl | 0-60 wt % |

If required, said electrolyte composition may include from 0 to 10 wt % of a water soluble bromide salt selected from the group consisting of NaBr, LiBr, KBr, CaBr₂, MgBr₂ or mixtures thereof.

If required, said electrolyte composition may include from 0 to 10 wt % of a soluble zinc halide salt.

If required, said electrolyte composition may include from 0 to 10 wt % of ascorbic acid.

If required, said, electrolyte composition may contain 0 to 10 wt % of zinc ascorbate.

Suitably, said electrolyte composition comprises a concentrated aqueous solution.

### DETAILED DESCRIPTION

This invention relates to an improved method of water sanitisation that was developed after the inventors surprisingly found that the system previously described in WO2008/000029 may operate with significantly lower levels of electrolytes with no deleterious effects on pool water hygiene. The advantages of the lower concentration include lower use of chemicals with resulting cost savings, reduced environmental pollution, and significant health benefits due to substantially reduced levels of disinfection by-products (DBPs) including chloramines and trihalomethanes.

The invention will primarily be described with reference to its use to provide sanitisation of swimming pool and spa water containing bacteria, algae and other water-borne diseases, but it should be remembered that the invention can have broader applications to any other body of water which may contain such organisms and diseases and which therefore require sanitisation.

Swimming pool owners are recommended to backwash the filtration system at regular intervals, such as weekly or fortnightly, to maintain the hygiene of the swimming pool water. Under more adverse conditions such as elevated summer time ambient conditions and/or contamination from windborne dust and the like, more frequent backwashing may be required to avoid clogging of the filter or reduced water flow therethrough.

In addition, after rain events, it may be necessary to reduce the water level in the pool to a desired level by pumping out excess water to a storm drain via a waste conduit.

A typical filter pump will pump water to waste at a rate of about 350 litres per minute and a backwash cycle may be from 2 to 10 minutes depending upon the extent of contamination of the filtration medium. Over a year, this could result in a water consumption of between 35 kilolitres to 175 kilolitres, not taking into account evaporative losses.

Apart from the waste of a precious resource and the consequent cost to the community arising therefrom, many local government authorities are proposing serious financial penalties for users of water over a predetermined volume, typically an average household consumption value.

While other water conservation measures such as rainwater storage tanks and grey water reticulation systems for garden purposes have been proposed, overflow, backwash and rinse water from electrolytically chlorinated swimming pools is unsuited for garden use due to a high concentration of sodium chloride at about 6000 ppm.

Experiments previously described in WO20081000029 have shown that by replacing NaCl at a recommended concentration of 6000 ppm with chloride (e.g. KCl) at a concentration of about 2500 ppm to 3000 ppm, a chlorine concentration of between 1 ppm to 3 ppm of chlorine can be maintained in an electrolytically chlorinated swimming pool with no deleterious effects on pool water hygiene.

Given that unacceptably high levels of disinfection by-products (DBPs) are still present in swimming pools, the present invention seeks to utilize a combination of sources of ionic chlorine which can allow effective chlorine levels in the swimming pool water at substantially lower concentrations than conventional NaCl sources and previously used KCl and MgCl₂ sources.

In one aspect, the invention therefore provides a method for water sanitisation, said method including the steps of forming, in a body of water, an electrolyte solution containing from 500 ppm to 9000 ppm of a soluble magnesium halide salt;

treating said electrolyte solution in an electrolytic halogenation cell to form an aqueous solution of hypohalous acid; and

returning said treated electrolyte solution to said body of water.

In particular aspects, said electrolyte solution may contain 1000 ppm, 1500 ppm, 2000 ppm, 2500 ppm, 3000 ppm, 3500 ppm, 4000 ppm, 4500 ppm, 5000 ppm, 5500 ppm, 6000 ppm, 6500 ppm, 7000 ppm, 7500 ppm, 8000 ppm, 8500 ppm, or up to 9000 ppm of a soluble magnesium halide salt.

Preferably, said electrolyte solution contains from 700 ppm to 3000 ppm of a soluble magnesium halide salt. For example, said electrolyte solution may contain 800 ppm, 900 ppm, 1000 ppm, 1100 ppm, 1200 ppm, 1300 ppm, 1400 ppm, 1500 ppm, 1600 ppm, 1700 ppm, 1800 ppm, 1900 ppm, 2000 ppm, 2100 ppm, 2200 ppm, 2300 ppm, 2400 ppm, 2500 ppm, 2600 ppm, 2700 ppm, 2800 ppm, 2900 ppm, or up to 3000 ppm of a soluble magnesium, halide salt.

More preferably, said electrolyte solution contains from 700 ppm to 1500 ppm of a soluble magnesium halide salt. Said electrolyte solution may, for example, contain 725 ppm, 775 ppm, 825 ppm, 875 ppm, 925 ppm, 975 ppm, 1025 ppm, 1075 ppm, 1125 ppm, 1175 ppm, 1225 ppm, 1275 ppm, 1325 ppm, 1375 ppm, 1425 ppm, 1475 ppm, or up to 1500 ppm of a soluble magnesium halide salt.

Suitably, said electrolyte solution contains from 250 ppm to 4000 ppm of a soluble sodium halide salt. Accordingly, said electrolyte solution may contain 500 ppm, 750 ppm, 1000 ppm, 1250 ppm, 1500 ppm, 1750 ppm, 2000 ppm, 2250 ppm, 2500 ppm, 2750 ppm, 3000 ppm, 3250 ppm, 3500 ppm, 3750 ppm, or up to 4000 ppm of a soluble sodium halide salt.

Preferably, said electrolyte solution contains from 375 ppm to 2000 ppm of a soluble sodium halide salt. Thus, said electrolyte solution may contain 750 ppm, 1125 ppm, 1500 ppm, 1875 ppm, or up to 2000 ppm of a soluble sodium halide salt.

Suitably, said electrolyte solution contains from 0 to 4000 ppm of a soluble potassium halide salt. Accordingly, said electrolyte solution may contain 500 ppm, 1000 ppm, 1500 ppm, 2000 ppm, 2500 ppm, 3000 ppm, 3500 ppm, or up to 4000 ppm of a soluble potassium halide salt.

Preferably, said electrolyte solution contains from 0 to 3000 ppm of a soluble potassium halide salt. More preferably, said electrolyte solution contains from 0 to 2500 ppm of a soluble potassium halide salt.

If required, the electrolyte solution may contain from 0 to 300 ppm of a soluble alkali metal halide salt selected, from LiBr, NaBr, CaBr₂, MgBr₂ or mixtures thereof.

If required, the electrolyte solution may contain from 0 to 1000 ppm of a soluble zinc halide salt.

If required, the electrolyte solution may contain from 0 to 1000 ppm of ascorbic acid.

If required, the electrolyte solution may contain from 0 to 1000 ppm of zinc ascorbate.

Preferably, said magnesium halide, potassium halide and sodium halide salts are chloride salts. Suitably, said electrolyte solution contains from 1000 ppm to 5000 ppm of soluble metal halide salts. Accordingly, said electrolyte solution may contain 2000 ppm, 3000 ppm, 4000 ppm, or up to 5000 ppm of soluble metal halide salts.

Preferably, said electrolyte solution contains from 1500 ppm to 4000 ppm of soluble metal halide salts. Said electrolyte solution may, for example, contain 1750 ppm, 2000 ppm, 2250 ppm, 2500 ppm, 2750 ppm, 3000 ppm, 3250 ppm, 3500 ppm, 3750 ppm, or up to 4000 ppm of halide salts. More preferably, said electrolyte solution contains 2000 ppm to 3000 ppm of soluble metal halide salts. Accordingly, said electrolyte solution may contain 2100 ppm, 2200 ppm, 2300 ppm, 2400 ppm, 2500 ppm, 2600 ppm, 2700 ppm, 2800 ppm, 2900 ppm, or up to 3000 ppm of soluble metal halide salts.

Suitably, said electrolyte solution is filtered through a filter medium before return to said body of water.

Preferably, said filter medium comprises a particulate amorphous siliceous composition.

Desirably, said filter medium comprises crushed or milled glass particles.

Preferably, said electrolyte solution is directed to said electrolytic halogenation cell via a settling tank to assist in separation of particulate contaminants.

Typically, although not exclusively, said settling tank is a crushed or milled glass filtration tank that assists in the accumulation of combined particulate/magnesium coagulants and/or flocs. It will be appreciated that the accumulation of the coagulants and/or flocs at least partly reduces the turbidity of the water in the body of water (e.g. the swimming pool). It will also be appreciated that the crushed or milled glass filtration tank at least partly removes precursors (e.g. phosphate) that would otherwise combine with chlorine in the body of water to form trihalomethanes.

Alternatively, said electrolyte solution is directed, during a backwash, rinse or bypass cycle to a collection tank.

According to another aspect of the invention, there is provided an electrolyte salt composition for use with the aforementioned method, said electrolyte salt composition comprising:

| | |
|---|---|
| MgCl₂ | 100-20 wt % |
| NaCl | 0-60 wt % |
| KCl | 0-70 wt % |

Accordingly, said electrolyte salt composition may comprise 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 95 wt %, or up to 100 wt % of MgCl₂:

It will also be appreciate that said electrolyte salt composition may comprise 5 wt %, 10 wt %, 15 wt %, 20 wt %, 25 wt %, 30 wt %, 35 wt %, 40 wt %, 45 wt %, 50 wt %, 55 wt %, or up to 60 wt % of NaCl.

Furthermore, said electrolyte salt composition may comprise 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, or up to 70 wt % of KCl.

If required, said electrolyte composition may include from 0 to 10 wt % of a water soluble bromide salt selected from NaBr, LiBr, KBr, CaBr₂, MgBr₂ or mixtures thereof.

If required, said electrolyte composition may comprise from 0 to 10 wt % of a soluble zinc halide salt.

If required, said electrolyte composition may comprise from 0 to 10 wt % of ascorbic acid.

If required, said electrolyte composition may contain 0 to 10 wt % of zinc ascorbate.

Suitably, said electrolyte composition comprises a concentrated aqueous solution.

Although not wishing to be bound by any particular hypothesis, it is considered that potassium anions are taken up by plants as a fertilizer and the free chlorine cations associate to form chlorine gas in such minute amounts as to be highly diluted by air to the extent that any otherwise harmful oxidizing effect on the vegetation is largely avoided. Indeed, a compound known as “muriate of potash” containing about 80-97% of KCl is sold widely as a commercial fertilizer rating 0-0-60 in NKP ratio. There are reports that application of potassium chloride to certain crops provided an enhanced resistance to fungal infections. For swimming pools however, a much more refined grade is required to avoid unsightly staining in the swimming pool and corrosion or scaling in the filtration system.

Further investigations into environmentally acceptable chlorine containing electrolytes revealed that magnesium chloride (MgCl₂) is used as a secondary fertilizer as a source of both magnesium and chloride ions essential for healthy plant development.

An unexpected benefit of utilizing MgCl₂ as a source of chloride ions for swimming pool sanitisation is its flocculation capacity.

Flocculation is a process whereby particles suspended in the water are attracted to the flocculating agent and bound to it. This forms larger particles that will cease to be suspended in the water. These combined particles or “flocs” can be filtered from the water more easily than the original suspended particles.

Magnesium is a multi-valent positive ion, and can attract multiple suspended particles. Organic molecules tend to have a slight negative “dipole” due to the functional groups attached to the hydrocarbon base structure (which has no dipole charge). The slight-negative charge on the outer surface of organic molecules are attracted to the strong positive charge of the magnesium ions, leading to the formation of flocs of multiple organic molecules surrounding the small strongly charged magnesium ion. These flocs become too large and heavy to be suspended in the water and also larger than their component molecules for the purposes of filtration.

In the pool, flocs can be filtered out as the water is cycled through a pool filtration system. This leads to cleaner water, since particles that would have bypassed the filter previously will be filtered out now that they are part of larger structures.

In a collection/settling tank, the flocs will have time to settle at the bottom of the tank (below the outlet point). This will help to raise the water quality of the collected water and to reduce available nutrients for micro-organisms in the water. A collection tank is for collection of waste water from a swimming pool for conservation reasons may also serve as a settling tank.

Although not wishing to be bound by any particular hypothesis, it is considered that magnesium ions (Mg²⁺), from MgCl₂, bind PO₄³⁻, resulting in the formation of an insoluble complex that sinks to the bottom of the pool and can easily be vacuumed up. The Magnesium phosphate complex may be monobasic (Mg(H₂PO₄)₂), Magnesium phosphate dibasic (MgHPO₄), or Magnesium phosphate tribasic (Mg₃(PO₄)₂). Given that the levels of Mg²⁺ required to “sequester” the phosphate are very low, it is not necessary to increase the levels of MgCl₂ in the pool. A particularly advantageous feature of the flocculation capacity of the Mg²⁺ ions is that a large proportion of the phosphate becomes removed (due to the sequestering capacity of the Mg²⁺ ions) before reacting with chloride, which at least partly reduces the production of chloramines and trihalomethanes (THMs).

THMs (e.g. chloroform, bromoform, dibromochloromethane, and bromodichloromethane) are the most abundant by-products of chlorination and their total concentration depends upon total organic carbon, the number of swimmers and the water temperature. Individuals are exposed to THMs through ingestion, dermal contact and inhalation and these toxic substances have been recognized as a potential health concern. Although not limiting ourselves to any particular hypothesis, it will be appreciated that an at least partial reduction of the levels of THMs present in a swimming pool will be advantageous. THMs are, for example, considered to be carcinogenic substances that damage the liver, the kidneys and the central nervous system. It has also been proposed that extended exposure to THMs (either in or adjacent to a swimming pool or the like) is associated with adverse reproductive outcomes such as spontaneous abortion, birthweight, neural tube defects, and urinary tract defects. Furthermore, many pool attendants suffer from forgetfulness, fatigue, chronic colds, voice problems, eye irritations, headache, sore throat, and frontal sinus inflammation following extended exposure to THMs.

The inclusion of a small amount of a soluble metal bromide such as KBr is believed to enhance the oxidative sterilization of swimming pool water by the generation of a small amount of bromide gas in admixture with chlorine gas but at a concentration range where the colour and odour of bromine gas is imperceptible.

In this embodiment, the generation of oxidizing chlorine and bromine gases is efficient and the sterilizing effect of potassium and/or magnesium chlorides aids the overall sterilization process. Moreover, backwash water from a swimming pool or spa or from an effluent treatment system may be safely disposed of into the environment, either into a waterway or as a fertilizer containing source of water for gardens and the like.

Zinc is essential to both our physical and mental health. From healthy skin, hair and nails, to muscle, nerve and brain functions, zinc plays a key role. Teeth, bones, the healing process, and the immune and reproduction systems are all dependent on a sufficient amount of zinc in our bodies.

Although not limiting ourselves to any particular hypothesis, zinc has been proposed to alleviate a range of skin conditions including acne and eczema (i.e. atopic dermatitis). Zinc has also been shown to play an important role in wound healing and plays a vital role in many biological functions including diabetes control, stress levels, reproduction, immune resistance, appetite and digestion. Other benefits of zinc include its antioxidant activities and it has been suggested that adequate levels of zinc may reduce an individual's risk of cancer (e.g. prostate cancer).

Ascorbic acid (or vitamin C, which is the L-enantiomer of ascorbic acid) is involved in the formation and maintenance of collagen and is therefore required for wound healing, and to maintain healthy skin and blood vessels. Vitamin C helps thyroid function and plays a significant role in cellular immune functions, where it may be helpful against viral, fungal and bacterial diseases. Vitamin C may also decrease the production of histamine thereby at least partly reducing allergy symptoms.

Without limiting ourselves to any particular hypothesis, it has been proposed that ascorbic acid may help reduce the levels of trichloramines in a swimming pool. Suitably, this at least partly reduces the respiratory symptoms that are associated with exposure to trichloramines (e.g. asthma and bronchitis).

It will be appreciated that the method for water sanitisation disclosed herein may be particularly suitable for use with the system for conserving waste water from a swimming pool which was previously described in, and shown in FIG. 1, of WO2008/000029.

The use of reduced levels of magnesium chloride as a source of chlorine ions in an electrolytic pool chlorinator, apart from its claimed pharmacological benefits, alone or in combination with potassium chloride and/or sodium chloride, permits disposal of waste water from a swimming pool or the like in a much more environmentally responsible manner than the previously described higher levels of electrolytes. Moreover, as both magnesium and potassium are important for plant growth and nutrition, disposal of swimming pool waste water on gardens or the like is beneficial to plants rather than deleterious as otherwise would be the case with sodium chloride electrolytes.

It readily will be apparent to a person skilled in the art that many modifications and variations may be made to the various aspects of the invention without departing from the spirit and scope thereof. The present invention may be further understood in light of the following examples, which are illustrative in nature and are not to be considered as limiting the scope of the invention.

### EXAMPLES

Examples 1-8 are non-limiting examples which illustrate a method of sanitisation of a swimming pool using a formula comprising from 2000 ppm to 4000 ppm of soluble magnesium, sodium and potassium halide salts. The range of MgCl₂ is from 700 ppm to 1500 ppm which is a significant reduction compared to the electrolyte levels previously defined in WO2008/000029. The inventors surprisingly discovered that it is possible to use lower electrolyte levels while still maintaining adequate chlorine levels for efficient sanitisation of a swimming pool. Associated advantages include lower use of chemicals with resulting cost savings, reduced environmental damage, and at least partly reduced levels of disinfection by-products (DBPs) including chloramines and trihalomethanes (THMs). The levels and percentages of the different electrolytes and the total electrolyte levels are listed below. Further information, including chloride content and conductivity, may be found in the attached tables.

### Example 1

### MgCl₂: 1183.3 ppm (30 wt %)

### NaCl: 591.6 ppm (15 wt %)

### KCl: 2169.4 ppm (55 wt %)

Total level: 3944.3 ppm

### Example 2

### MgCl₂: 944.5 ppm (30 wt %)

### NaCl: 1259.3 ppm (40 wt %)

### KCl: 944.5 ppm (30 wt %)

Total level: 3148.3 ppm

### Example 3

### MgCl₂: 928.8 ppm (30 wt %)

### NaCl: 1548 ppm (50 wt %)

### KCl: 619.2 ppm (20 wt %)

Total level: 3096 ppm

### Example 4

### MgCl₂: 913.6 ppm (30 wt %)

### NaCl: 1827.3 ppm (60 wt %)

### KCl: 304.5 ppm (10 wt %)

Total level: 3045.5 ppm

### Example 5

### MgCl₂: 921.2 ppm (30 wt %)

### NaCl: 1688.8 ppm (55 wt %)

### KCl: 460.6 ppm (15 wt %)

Total level: 3070.6 ppm

### Example 6

### MgCl₂: 1103 ppm (35 wt %)

### NaCl: 1733.3 ppm (55 wt %)

### KCl: 315.2 ppm (10 wt %)

Total level: 3151.5 ppm

### Example 7

### MgCl₂: 788.9 ppm (30 wt %)

### NaCl: 394.4 ppm (15 wt %)

### KCl: 1446.3 ppm (55 wt %)

Total level: 2629.6 ppm

### Example 8

### MgCl₂: 736.9 ppm (30 wt %)

### NaCl: 1351 ppm (55 wt %)

### KCl: 368.5 ppm (15 wt %)

Total level: 2456.4 ppm

It will be appreciated that the levels of the different electrolytes, particularly the sodium and potassium halide salts, may be adjusted to suit a particular system and a user thereof. Accordingly, a smaller body of water (e.g. a spa bath), which is primarily used for its healing and therapeutic effects may, for example, contain higher levels of KCl (e.g. 55 wt % as shown in Examples 1 and 7). Furthermore, in view of the higher costs involved in maintaining satisfactory levels of disinfectants in a large body of water, such as a swimming pool, a user may adjust the levels of the sodium and potassium halide salts accordingly. This is, for example, illustrated in Example 4, where the level of NaCl is increased to 60 wt % while the total level of electrolytes is maintained at a low level (i.e. ˜3000 ppm). Due to the beneficial effects of the magnesium halide salt, the MgCl₂ level will typically not be lower than 20 wt % in the body of water.

EXAMPLE 1

| | Weight per bag | Weight per 10k | Concentration | Content by weight | | Chloride | Conductivity |
|---|---|---|---|---|---|---|---|
| Component | (kg) | (kg) | (ppm) | Active (kg) | Water (kg) | content | Estimate |
| Sodium chloride | 1.5 | 5.9 | 591.6 | 1.50 | 0.00 | 0.910 | 1.500 |
| Magnesium chloride (anhydrous) | | 0.0 | 0.0 | 0.00 | 0.00 | 0.000 | 0.000 |
| Magnesium chloride (hexahydrate) | 3 | 11.8 | 1183.3 | 1.41 | 1.59 | 1.050 | 1.343 |
| Boric acid | | 0.0 | 0.0 | 0.00 | 0.00 | 0.000 | 0.000 |
| Potassium chloride | 5.5 | 21.7 | 2169.4 | 5.50 | 0.00 | 2.615 | 4.763 |
| Total | 10 | 39.4 | 3944.3 | 8.41 | 1.59 | 4.575 | 7.606 |

Weight per bag (kg) 10
Weight per 10,000 l 39.44
Bags per 10,000 l 3.94
Estimated conductivity in pool 3000
Chloride ppm in pool 1804.6

EXAMPLE 2

| | Weight per bag | Weight per 10k | Concentration | Content by weight | | Chloride | Conductivity |
|---|---|---|---|---|---|---|---|
| Component | (kg) | (kg) | (ppm) | Active (kg) | Water (kg) | content | Estimate |
| Sodium chloride | 4 | 12.6 | 1259.3 | 4.00 | 0.00 | 2.426 | 4.000 |
| Magnesium chloride (anhydrous) | | 0.0 | 0.0 | 0.00 | 0.00 | 0.000 | 0.000 |
| Magnesium chloride (hexahydrate) | 3 | 9.4 | 944.5 | 1.41 | 1.59 | 1.050 | 1.343 |
| Boric acid | | 0.0 | 0.0 | 0.00 | 0.00 | 0.000 | 0.000 |
| Potassium chloride | 3 | 9.4 | 944.5 | 3.00 | 0.00 | 1.427 | 2.598 |
| Total | 10 | 31.5 | 3148.3 | 8.41 | 1.59 | 4.903 | 7.941 |

Weight per bag (kg) 10
Weight per 10,000 l 31.48
Bags per 10,000 l 3.15
Estimated conductivity in pool 2500
Chloride ppm in pool 1543.6

EXAMPLE 3

| | Weight per bag | Weight per 10k | Concentration | Content by weight | | Chloride | Conductivity |
|---|---|---|---|---|---|---|---|
| Component | (kg) | (kg) | (ppm) | Active (kg) | Water (kg) | content | Estimate |
| Sodium chloride | 5 | 15.5 | 1548.0 | 5.00 | 0.00 | 3.033 | 5.000 |
| Magnesium chloride (anhydrous) | | 0.0 | 0.0 | 0.00 | 0.00 | 0.000 | 0.000 |
| Magnesium chloride (hexahydrate) | 3 | 9.3 | 928.8 | 1.41 | 1.59 | 1.050 | 1.343 |
| Boric acid | | 0.0 | 0.0 | 0.00 | 0.00 | 0.000 | 0.000 |
| Potassium chloride | 2 | 6.2 | 619.2 | 2.00 | 0.00 | 0.951 | 1.732 |
| Total | 10 | 31.0 | 3096.0 | 8.41 | 1.59 | 5.034 | 8.075 |

Weight per bag (kg) 10
Weight per 10,000 l 30.96
Bags per 10.000 l 3.10
Estimated conductivity in pool 2500
Chloride ppm in pool 1558.6

EXAMPLE 4

| | Weight per bag | Weight per 10k | Concentration | Content by weight | | Chloride | Conductivity |
|---|---|---|---|---|---|---|---|
| Component | (kg) | (kg) | (ppm) | Active (kg) | Water (kg) | content | Estimate |
| Sodium chloride | 6 | 18.3 | 1827.3 | 6.00 | 0.00 | 3.640 | 6.000 |
| Magnesium chloride (anhydrous) | | 0.0 | 0.0 | 0.00 | 0.00 | 0.000 | 0.000 |
| Magnesium chloride (hexahydrate) | 3 | 9.1 | 913.6 | 1.41 | 1.59 | 1.050 | 1.343 |
| Boric acid | | 0.0 | 0.0 | 0.00 | 0.00 | 0.000 | 0.000 |
| Potassium chloride | 1 | 3.0 | 304.5 | 1.00 | 0.00 | 0.476 | 0.866 |
| Total | 10 | 30.5 | 3045.5 | 8.41 | 1.59 | 5.165 | 8.209 |

Weight per bag (kg) 10
Weight per 10,000 l 30.45
Bags per 10,000 l 3.05
Estimated conductivity in pool 2500
Chloride ppm in pool 1573.0

EXAMPLE 5

| | Weight per bag | Weight per 10k | Concentration | Content by weight | | Chloride | Conductivity |
|---|---|---|---|---|---|---|---|
| Component | (kg) | (kg) | (ppm) | Active (kg) | Water (kg) | content | Estimate |
| Sodium chloride | 5.5 | 16.9 | 1688.8 | 5.50 | 0.00 | 3.336 | 5.500 |
| Magnesium chloride (anhydrous) | | 0.0 | 0.0 | 0.00 | 0.00 | 0.000 | 0.000 |
| Magnesium chloride (hexahydrate) | 3 | 9.2 | 921.2 | 1.41 | 1.59 | 1.050 | 1.343 |
| Boric acid | | 0.0 | 0.0 | 0.00 | 0.00 | 0.000 | 0.000 |
| Potassium chloride | 1.5 | 4.6 | 460.6 | 1.50 | 0.00 | 0.713 | 1.299 |
| Total | 10 | 30.7 | 3070.6 | 8.41 | 1.59 | 5.100 | 8.142 |

Weight per bag (kg) 10
Weight per 10,000 l 30.71
Bags per 10,000 l 3.07
Estimated conductivity in pool 2500
Chloride ppm in pool 1565.9

EXAMPLE 6

| | Weight per bag | Weight per 10k | Concentration | Content by weight | | Chloride | Conductivity |
|---|---|---|---|---|---|---|---|
| Component | (kg) | (kg) | (ppm) | Active (kg) | Water (kg) | content | Estimate |
| Sodium chloride | 5.5 | 17.3 | 1733.3 | 5.50 | 0.00 | 3.336 | 5.500 |
| Magnesium chloride (anhydrous) | | 0.0 | 0.0 | 0.00 | 0.00 | 0.000 | 0.000 |
| Magnesium chloride (hexahydrate) | 3.5 | 11.0 | 1103.0 | 1.65 | 1.86 | 1.225 | 1.567 |
| Boric acid | | 0.0 | 0.0 | 0.00 | 0.00 | 0.000 | 0.000 |
| Potassium chloride | 1 | 3.2 | 315.2 | 1.00 | 0.00 | 0.476 | 0.866 |
| Total | 10 | 31.5 | 3151.5 | 8.15 | 1.86 | 5.037 | 7.933 |

Weight per bag (kg) 10
Weight per 10,000 l 31.52
Bags per 10,000 l 3.15
Estimated conductivity in pool 2500
Chloride ppm in pool 1587.4

EXAMPLE 7

| | Weight per bag | Weight per 10k | Concentration | Content by weight | | Chloride | Conductivity |
|---|---|---|---|---|---|---|---|
| Component | (kg) | (kg) | (ppm) | Active (kg) | Water (kg) | content | Estimate |
| Sodium chloride | 1.5 | 3.9 | 394.4 | 1.50 | 0.00 | 0.910 | 1.500 |
| Magnesium chloride (anhydrous) | | 0.0 | 0.0 | 0.00 | 0.00 | 0.000 | 0.000 |
| Magnesium chloride (hexahydrate) | 3 | 7.9 | 788.9 | 1.41 | 1.59 | 1.050 | 1.343 |
| Boric acid | | 0.0 | 0.0 | 0.00 | 0.00 | 0.000 | 0.000 |
| Potassium chloride | 5.5 | 14.5 | 1446.3 | 5.50 | 0.00 | 2.615 | 4.763 |
| Total | 10 | 26.3 | 2629.6 | 8.41 | 1.59 | 4.575 | 7.606 |

Weight per bag (kg) 10
Weight per 10,000 l 26.30
Bags per 10,000 l 2.63
Estimated conductivity in pool 2000
Chloride ppm in pool 1203.1

EXAMPLE 8

| | Weight per bag | Weight per 10k | Concentration | Content by weight | | Chloride | Conductivity |
|---|---|---|---|---|---|---|---|
| Component | (kg) | (kg) | (ppm) | Active (kg) | Water (kg) | content | Estimate |
| Sodium chloride | 5.5 | 13.5 | 1351.0 | 5.50 | 0.00 | 3.336 | 5.500 |
| Magnesium chloride (anhydrous) | | 0.0 | 0.0 | 0.00 | 0.00 | 0.000 | 0.000 |
| Magnesium chloride (hexahydrate) | 3 | 7.4 | 736.9 | 1.41 | 1.59 | 1.050 | 1.343 |
| Boric acid | | 0.0 | 0.0 | 0.00 | 0.00 | 0.000 | 0.000 |
| Potassium chloride | 1.5 | 3.7 | 368.5 | 1.50 | 0.00 | 0.713 | 1.299 |
| Total | 10 | 24.6 | 2456.4 | 8.41 | 1.59 | 5.100 | 8.142 |

Weight per bag (kg) 10
Weight per 10,000 l 24.56
Bags per 10,000 l 2.46
Estimated conductivity in pool 2000
Chloride ppm in pool 1252.7

1. A method for water sanitisation, said method including the steps of forming, in a body of water, an electrolyte solution containing from 500 ppm to 9000 ppm of a soluble magnesium halide salt; treating said electrolyte solution in an electrolytic halogenation cell to form an aqueous solution of hypohalous acid; and returning said treated electrolyte solution to said body of water.

2. The method of claim 1, wherein said electrolyte solution contains from 700 ppm to 3000 ppm of a soluble magnesium halide salt.

3. The method of claim 2, wherein said electrolyte solution contains from 700 ppm to 1500 ppm of a soluble magnesium halide salt.

4. The method of any one of claims 1-3, wherein said electrolyte solution contains from 250 ppm to 4000 ppm of a soluble sodium halide salt.

5. The method of claim 4, wherein said electrolyte solution contains from 375 ppm to 2000 ppm of a soluble halide salt.

6. The method of any one of claims 1-5, wherein said electrolyte solution contains from 0 to 4000 ppm of a soluble potassium halide salt.

7. The method of claim 6, wherein said electrolyte solution contains from 0 to 3000 ppm of a soluble potassium salt.

8. The method of claim 7, wherein said electrolyte solution contains from 0 to 2500 ppm of a soluble potassium salt.

9. The method of any one of claims 1-8, wherein said electrolyte solution further comprises from 0 ppm to 300 ppm of a soluble alkali metal halide salt selected from LiBr, NaBr, CaBr₂, MgBr₂ or mixtures thereof.

10. The method of any one of claims 1-9, wherein said electrolyte solution further comprises from 0 to 1000 ppm of a soluble zinc halide salt.

11. The method of any one of claims 1-10, wherein said electrolyte solution further comprises from 0 to 1000 ppm of ascorbic acid.

12. The method of any one of claims 1-11, wherein said electrolyte solution further comprises from 0 to 1000 ppm of zinc ascorbate.

13. The method of any one of claims 1-12, wherein the magnesium halide, potassium halide and sodium halide salts are chloride salts.

14. The method of any one of claims 1-13, wherein said electrolyte solution contains from 1000 ppm to 5000 ppm of soluble metal halide salts.

15. The method of claim 14, wherein said electrolyte solution contains from 1500 ppm to 4000 ppm of soluble metal halide salts.

16. The method of claim 15, wherein said electrolyte solution contains from 2000 ppm to 3000 ppm of soluble metal halide salts.

17. The method of any one of claims 1-16, wherein said electrolyte solution is filtered through a filter medium before being returned to said body of water.

18. The method of claim 17, wherein said filter medium comprises a particulate amorphous siliceous composition.

19. The method of claim 17 or claim 18, wherein said filter medium comprises crushed or milled glass particles.

20. The method of any one of claims 1-19, wherein said electrolyte solution is directed to said electrolytic halogenation cell via a settling tank to assist in separation of particulate contaminants.

21. The method of claim 20, wherein said settling tank is a crushed or milled glass filtration tank.

22. The method of any one of claims 1-19, wherein said electrolyte solution is directed, during backwash, rinse or bypass cycle to a collection tank.

23. An electrolyte salt composition for use with the method of any one of claims 1-22, said electrolyte salt composition comprising:

| | |
|---|---|
| MgCl₂ | 100-20 wt % |
| KCl | 0-70 wt % |
| NaCl | 0-60 wt % |

24. The electrolyte salt composition of claim 23, further comprising from 0 to 10 wt % of a water soluble bromide salt selected from the group consisting of NaBr, LiBr, KBr, CaBr₂, MgBr₂ or mixtures thereof.

25. The electrolyte salt composition of claim 23 or claim 24, further comprising from 0 to 10 wt % of a soluble zinc halide salt.

26. The electrolyte salt composition of any one of claims 23-25, further comprising from 0 to 10 wt % of ascorbic acid.

27. The electrolyte salt composition of any one of claims 23-26, further comprising from 0 to 10 wt % of zinc ascorbate.

28. The electrolyte salt composition of any one of claims 23-27, which comprises a concentrated aqueous solution.
